(19) United States
(12) Patent Application Publication
(10) Pub. No.: US 2004/0193737 A1
(43) Pub. Date: Sep. 30, 2004

(54) Apparatus, method and system to couple one or more hosts to a storage device using unique signal from host

(76) Inventors: Amber D. Huffman, Banks, OR (US); Knut S. Grimsrud, Forest Grove, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/404,956

(22) Filed: Mar. 31, 2003

(51) Int. Cl. G06F 3/00

(52) U.S. Cl. 710/1

(57) ABSTRACT

In some embodiments, a system includes a switch coupled to a first host, a second host and a storage device. The switch is to decouple the second host from the storage device in response to a signal received from the first host, and to couple the first host to the storage device in response to the signal received from the first host. The signal is a valid signal, sequence of valid signals or combination of valid signals in a communication protocol used between the first host and the switch. Other embodiments are described and claimed.

### TECHNICAL FIELD

The present inventions generally relate to coupling one or more hosts to a storage device.

### BACKGROUND

Computer systems typically include some type of storage device such as one or more hard disk drives and/or other types of storage devices such as optical storage media. Storage has become so important that many computer systems include separate storage systems or subsystems dedicated to storing data. Storage devices store critical data that cannot be allowed to be lost due to a failure in the system. Failure of storage devices (such as hard drives) themselves may be addressed through RAID schemes (Redundant Arrays of Independent Disks). However, RAID by itself does not eliminate the possibility of a single point-of-failure, since the controller or host may fail. In order to address the no-single-point-of-failure needs of some solutions, a combination of RAID and a technique known as “fail-over” is required in order to accommodate the presence of a redundant controller and a redundant host. As an example, fail-over is generally a way to include redundant components such as redundant controllers in a system such that if a failure in one controller occurs, control may be switched over to the other non-failing controller.

Some arrangements are used in some high-end storage subsystems where it is important to have no single point of failure. However, such arrangements typically add a large expense to the storage system since expensive storage devices (such as disks), software, firmware and other items are required to be included. For example, some Fibre Channel dual port multi-initiator devices have been used either as a part of the storage device or as a separate device. Such devices use two ports that provide a coupling between the storage device and two hosts. Each of the two ports is active at the same time such that the two hosts are each coupled to the storage device continuously. If the host attached to one of the two ports fails in some way the host attached to the other port can continue to communicate with the storage device. This type of Fibre Channel dual port multi-initiator arrangement requires substantial complications that significantly increase the cost of the system. The many complications of such an arrangement include being forced to use dual-ported drives and the problem of using drive firmware which is multi-initiator capable and needs to keep track of issues such as which commands are being executed from which host.

Other arrangements of which the inventors of the inventions are aware include fail-over devices where a signal is hard wired from a host to a fail-over device to signal a switch from coupling a storage device from one host and uncoupling it from another. Complications of these types of arrangements include not being able to use known available controllers or hosts without requiring additional special wiring from the controllers or hosts to implement a switch from one host or controller to another.

### BRIEF DESCRIPTION OF THE DRAWINGS

The inventions will be understood more fully from the detailed description given below and from the accompanying drawings of some embodiments of the inventions which, however, should not be taken to limit the inventions to the specific embodiments described, but are for explanation and understanding only.

FIG. 1 is a block diagram representation of storage systems according to some embodiments of the inventions.

FIG. 2 is a block diagram representation of storage systems according to some embodiments of the inventions.

FIG. 3 is a flow diagram of operation of some embodiments of the inventions.

FIG. 4 is a flow diagram of operation of some embodiments of the inventions.

FIG. 5 is a flow diagram of operation of some embodiments of the inventions.

FIG. 6 is a flow diagram of operation of some embodiments of the inventions.

FIG. 7 is a diagram of a signal waveform of some embodiments of the inventions.

### DETAILED DESCRIPTION

The inventions involve coupling one or more hosts to a storage device. In some embodiments of the inventions a unique signal may be used to trigger a switch between the hosts and the storage device in a manner that avoids any need for special wiring being routed to the switch. The unique signal may be generated using existing commercially available controllers or hosts that use existing protocols while maintaining robustness.

In some embodiments of the inventions, the signaling scheme for the unique signal used to cause the switch to occur avoids the use of an additional signal to the switch and is transmitted in-band over a link with a host. In some embodiments of the inventions the signal is an irregular non-periodic signal. In some embodiments of the inventions the signal is also a valid signal in the protocol for the interface with the host, which can be a host currently disconnected from the storage device (known as the inactive host connected via the port known as the inactive port). In some embodiments of the inventions the signal is a sequence of signals that are valid signals in the protocol. In some embodiments of the inventions the sequence of signals is a Morse code scheme of signals using a hard reset signal already used in the protocol. In some embodiments of the inventions the unique signal or sequence of signals is in-band and in-protocol with the connection with the host via the host port.

Some embodiments of the inventions include a switch such as a storage fail-over switch that is used to provide this coupling. A storage fail-over switch is a component that provides two or more connection paths to a storage device. In some embodiments of the inventions, these connection paths can be from a host such as a host controller or a host computer, for example. According to some embodiments of the inventions, the two or more connection paths can include at least one active connection (can also be referred to as a “selected connection”, an “active port” or an “active connection”, for example) and at least one inactive connection (can also be referred to as a “non-selected connection”, an “inactive port” or an “inactive connection”, for example).

In some embodiments of the inventions, detection can be made of a condition of a host or a host controller communicating through the active port. The detected condition can be an error condition such as an error condition that the host or host controller communicating through the active port has failed in some way or is in a hung state, for example. In response to this detection the active port can be switched so that a different host or controller is able to access the storage device.

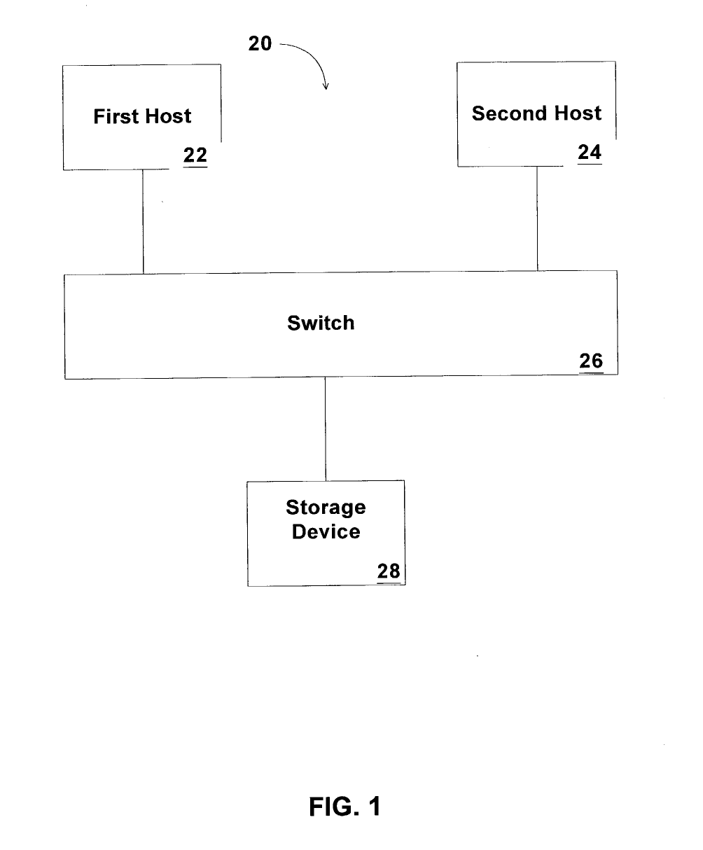

FIG. 1 illustrates a system 20, which is a storage system. Storage system 20 includes a first host 22, a second host 24, a switch 26 and a storage device 28. First host 22 is coupled to a first host port of switch 26 and second host 24 is coupled to a second host port of switch 26. Storage device 28 is coupled to a storage port of switch 26. Switch 26 can be a fail-over device that is logically a switch that functions like a circuit switch. Switch 26 operates such that one of the first host port and the second host port are connected to the storage device at any one time. The host port that is connected to the storage device at a particular time can also be referred to as the active host port, and the associated host can also be referred to as the active host. The host port that is not connected to the storage device at a particular time can also be referred to as the inactive host port, and the associated host can also be referred to as the inactive host. The inactive host port can be made the active port by transmitting from the inactive host a recognizable and unique signal or sequence of signals to the inactive host port. The switch receives the unique signal or sequence of signals from the inactive host port and selects the inactive host as the new active host and the active host as the new inactive host. The active host port is decoupled from the storage device and inactive host port is coupled to the storage device. This allows the new active host (the former inactive host) to become coupled to the storage device and the new inactive host (the former active host) to be decoupled from the storage device. In this manner the inactive host can be used to monitor activity of the active host and provide the signal to the switch if any failure or any other detected condition such as an error condition has occurred in the active host. The switch signal according to some embodiments of the inventions is sent in-band over the inactive communication link, and the signal is a valid communication signal for the inactive link. However, the signal is distinguishable as a special switch signal that is different from other signals.

Switch 26 can include in some embodiments of the inventions one or more detectors that implement logic to detect that a unique signal has been received via one of the host ports. One detector may be used in some embodiments, or two detectors may be used in other embodiments (one detector for each host port, with some way of communicating with each other).

Failures can be detected in many ways. For example, one way that failure detection may be implemented is by using two redundant hosts (or controllers) that share a “heartbeat” signal. This “heartbeat” signal can be used to verify that the other host (and/or controller) is still alive and active. When a failure (or some other condition of the other host and/or controller) is detected, the inactive host and/or controller detects that the “heartbeat” of the other host and/or controller has ceased. Upon such a detection the inactive host and/or controller can use that signal and provide a signal to grab control and switch the connection so that the ceased host/controller is no longer connected to the storage device.

The functions of switch 26 may be implemented in, for example, hardware, software, firmware, or some combination thereof. The storage device 28 can include one or more hard disk drives, one or more optical storage devices, or any other type of storage device or devices or combination of storage devices. The first host 22 and the second host 24 can be a computer, a server, a host computer, a controller, a RAID controller, or any other type of host, computer or controller.

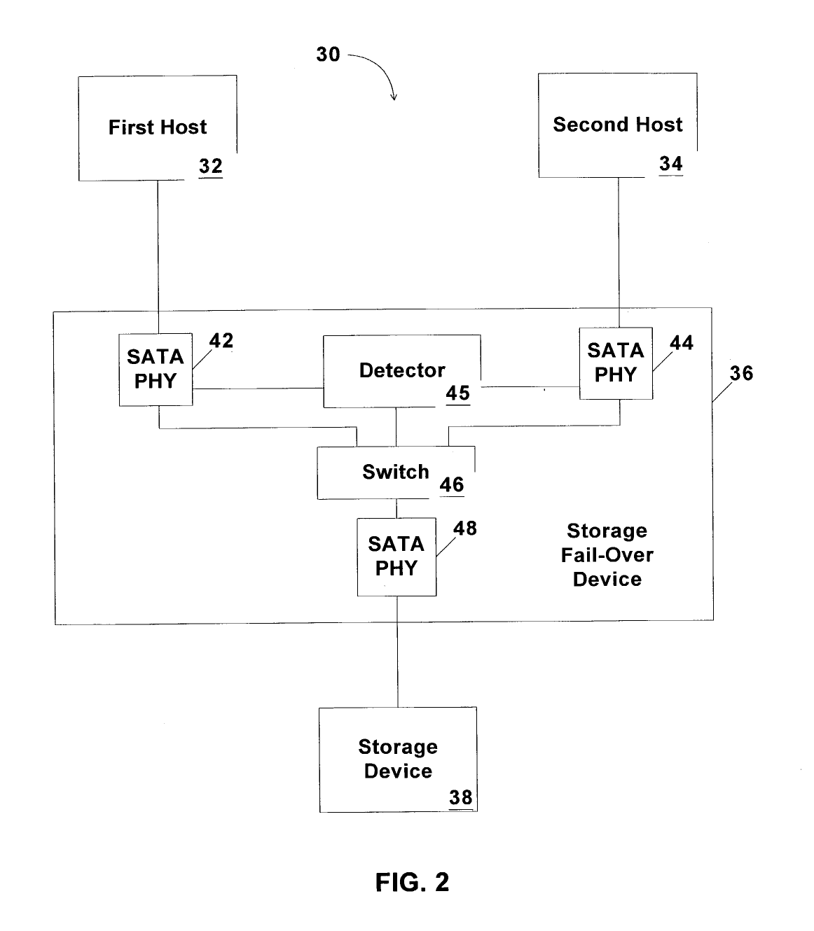

FIG. 2 illustrates a system 30, which is a storage system. System 30 includes a first host 32, a second host 34, a storage fail-over device 36 and a storage device 38. Storage fail-over device 36 includes a first Serial ATA PHY 42, a second Serial ATA PHY 44, Switch signal detector 45, Switch 46 and a third Serial ATA PHY 48.

Storage fail-over device 36 operates logically to provide fail-over logic, and can operate logically as a circuit switch or a mechanical relay. Storage fail-over device 36 can be implemented in hardware, software, firmware or any other way or combinations of ways. Switch signal detector 45 receives a switch signal from Serial ATA PHYs 42 and/or 44 and produces an output that drives the switch 46, causing the switch 46 to select one or the other of the PHYs 42 and 44 as the one having the signal that is fed through to the Serial ATA PHY (output) 48. Detector 45 and Switch 46 allow traffic from the associated active host Serial ATA PHY to connect to the storage device 38. The Serial ATA PHYs 42, 44 and 48 communicate with the first host 32, the second host 34 and the storage device 38, respectively, using a Serial ATA protocol such as Serial ATA 1.0 protocol. Some embodiments of the inventions include a separate switch signal detector 45 that detects a switch signal from the hosts. Alternatively such detector can also be included within switch 46 in some embodiments of the inventions.

The embodiment illustrated in FIG. 2 includes one detector 45. However, in some embodiments of the inventions two detectors (one for each host port) could be used with communication logic circuitry for the two detectors to communicate with each other.

Some embodiments use facilities already provided by the Serial ATA protocol, which is already supported in current disk drive and disk controller products. This allows support for switching between the first host port connected to first host 32 and the second host port connected to second host 34 using an in-band signal that is sufficiently robust and is not subject to being jammed on that wire as part of the failure mode. That is, the in-band signal for signaling the storage fail-over device 36 and switch 46 is not readily transmittable as part of being in some hung state.

In some embodiments of the inventions the fail-over signal used by the storage fail-over device 36, detector 45, and switch 46 to switch between the hosts and device ports can be based on the Serial ATA COMRESET signal used in the existing protocol for a hard reset. In some embodiments of the inventions using a switch similar to detector 45 and switch 46, the inactive host (whichever of the first host 32 and second host 34 are not actively connected to the storage device 38 at the time) detects a failure or hung state of the active host (the one of the hosts 32 and 34 that is connected to the storage device 38 at the time) or some other condition of the host. Once the inactive host or controller detects the condition, that inactive host or controller then asserts and deasserts the COMRESET signal in a distinctive, unique and/or detectable pattern transmitted to the storage fail-over device 36 via the corresponding host port. For example, the pattern may be in some prearranged Morse code type pattern of the COMRESET signal or some other irregular non-periodic signal waveform pattern. The storage fail-over device 36, detector 45 and/or the switch 46 receive this signal, and the signal causes the switch to deselect the currently active host port and select the host port over which the unique signal is received. The unique signal may be defined such that it can be generated using existing software mechanisms. The unique signal may also be defined such that it can be received and decoded without the need for the switch to include a full Link or Transport layer, that is the Phy itself may detect the unique signal. The switch has a requirement to be a high availability component, thus having no need for a full Link or Transport layer. This is a distinct advantage since it reduces the logic complexity and verification required for the switch component itself. This also allows a host to take control of a storage device even if the other host is hung and/or uncooperative by transmitting a unique detectable signal or combination or sequence of signals to the switch over the host port that is not hung or in some other state of failure or some other condition. Since the COMRESET signal is a pattern that is typically transmitted in a distinctive sequence, it is unlikely that a host port or host in a hung state would interfere with the switching over to the other host and host port. It is unlikely that a host would interfere with the switching because the other host port would not likely be transmitting a distinct signal or pattern or combination of signals such as a Morse code sequence of signals. Rather, in most failure modes, if the host is transmitting a signal at all, it is unlikely to transmit an irregular non-periodic signal as used in some embodiments of the inventions, but would be more likely to transmit a signal such as a steady stream signal.

Some embodiments of the inventions are described herein as being related to detection of a failure or hung state of an active host. However, those and other embodiments of the inventions could be implemented by detecting other conditions of the host and/or host controller and are not limited to detection of a failure or hung state of an active host, or to conditions specifically listed herein. Some embodiments of the inventions can detect any condition of a host or host controller. For example, other conditions than detecting a failure or hung state of the active host that may be desirable to switch control of a device from one controller or host to another according to some embodiments of the inventions can include a situation where a switch is made for load balancing purposes where the workload is distributed between two controllers or hosts in order to have them share equally in the load as well as other applications related to switching between hosts and controllers.

An advantage of using Serial ATA fail-over device as in FIG. 2 is a low implementation cost. A Serial ATA fail-over device allows the use of mainstream low cost Serial ATA storage devices in high availability systems, for example, allowing inexpensive disk drives to be used. Additionally, Serial ATA is not multi-initiator capable and a switch is generally an active/passive connection. While Serial ATA PHYs can be inexpensive, using a Serial ATA fail-over solution also allows a connection with commercially available Serial ATA disk drives that are packaged in a pluggable drive carrier. This solution allows high redundancy capabilities at a fraction of the cost of a solution that includes dual active ports with multi-initiator support (such as some Fibre Channel solutions).

Some embodiments of the inventions such as the embodiments illustrated and described in reference to FIG. 2 allow a signal to cause switching of the active port to be transmitted in-band over the existing connection itself. Existing Serial ATA host controllers can be used to control switching so that solutions according to some embodiments of the inventions can be implemented by supplying software and/or firmware with existing commercially available products. Such embodiments also do not require that storage devices such as disk drives provide any special additional support. Some embodiments of the inventions also allow a fail-over solution that can be designed using PHYs and not requiring complete Link & Transport layers as part of the solution.

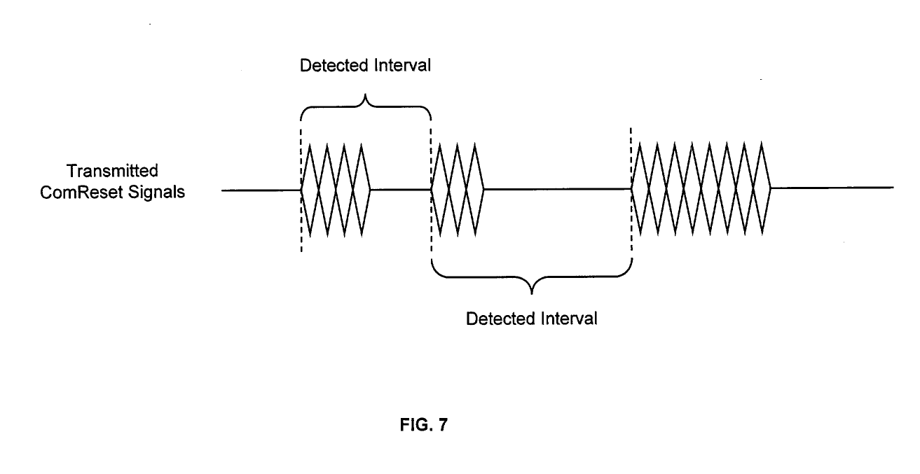

Some embodiments of the inventions use a special signal over the inactive port that is a signal that does not require hardware changes in the host. Some embodiments of the inventions use an out of band signal. Such an out of band (OOB) signal could include COMRESET and COMWAKE signals used as part of the SATA protocol. In some embodiments of the inventions the signal could be a unique sequence of COMRESET signals. A distinctive pattern of signals such as the COMRESET signal could be used in a manner similar to Morse code to set up the unique distinct pattern of signals. In some embodiments of the inventions the unique signal may be sent as a series of COMRESET signals with the timing from the assertion of one COMRESET signal to the assertion of the next COMRESET signal as shown in FIG. 7 and discussed in more detail below. The switch may select the inactive host port after receiving the unique signal with a specified inter-burst spacing (Morse coding) between the sequences of COMRESET signals. Alternatively, a combination of signals such as a COMRESET signal and/or a COMWAKE signal could be used to provide the unique and distinct pattern, those signals being sent in sequence and/or in some other unique and distinct manner. COMRESET is desirable to be used in some embodiments of the inventions because software can cause a COMRESET to be sent on demand when using some protocols such as Serial ATA 1.0. However, COMWAKE could also be used in embodiments of the inventions as mentioned above. Further, COMRESET and/or COMWAKE can be used advantageously in some embodiments of the inventions since they may be used with off the shelf host bus adapters. However, in some embodiments of the inventions another out-of-band (OOB) signal other than COMRESET or COMWAKE could be used instead of or in addition to one or both of those signals.

Although PHYs 42, 44 and 48 are illustrated as Serial ATA PHYs in FIG. 2 according to some embodiments of the inventions, some embodiments of the inventions may be used where the PHYs are other types of connections than PHYs or are other types of PHYs than Serial ATA PHYs using other communication protocols than Serial ATA or Serial ATA 1.0 such as any connection using a high speed serialized low voltage differential signaling protocol or some other type of protocol. For example, some embodiments of the inventions may be possible in systems implementing Serial ATA, 1394b, Fibre Channel, GigaBit Ethernet, SAS (Serial Attached SCSI), PCI-express, or some other protocol, particularly embodiments of the inventions where a unique out of band signal exists in the protocol used.

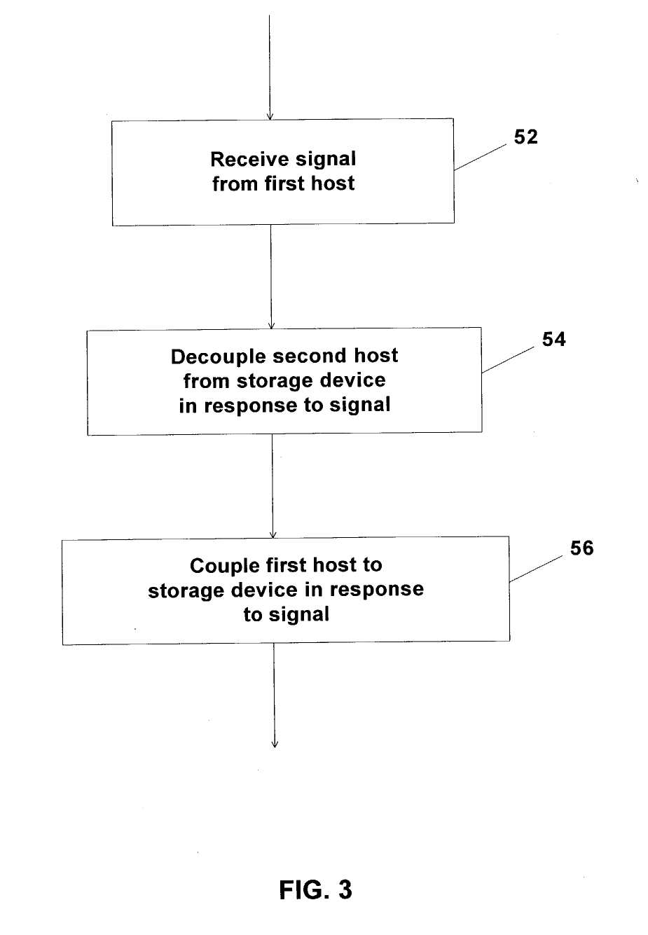

FIG. 3 illustrates functionality according to some embodiments of the inventions in flowchart form. This functionality could be included, for example, within switch 26 of system 20 illustrated in FIG. 1 or within switch 36 of system 30 illustrated in FIG. 2 or in other embodiments of the inventions. A signal is received from a first host (could be an inactive host) at box 52. In response to the signal, a second host (could be an active host) is decoupled from a storage device at box 54. In response to the signal, the first host is coupled to the storage device at box 56. In this manner, if the first host was originally an inactive host and the second host was originally an active host, the functionality illustrated in FIG. 3 can be used to make the first host an active host and the second host an inactive host.

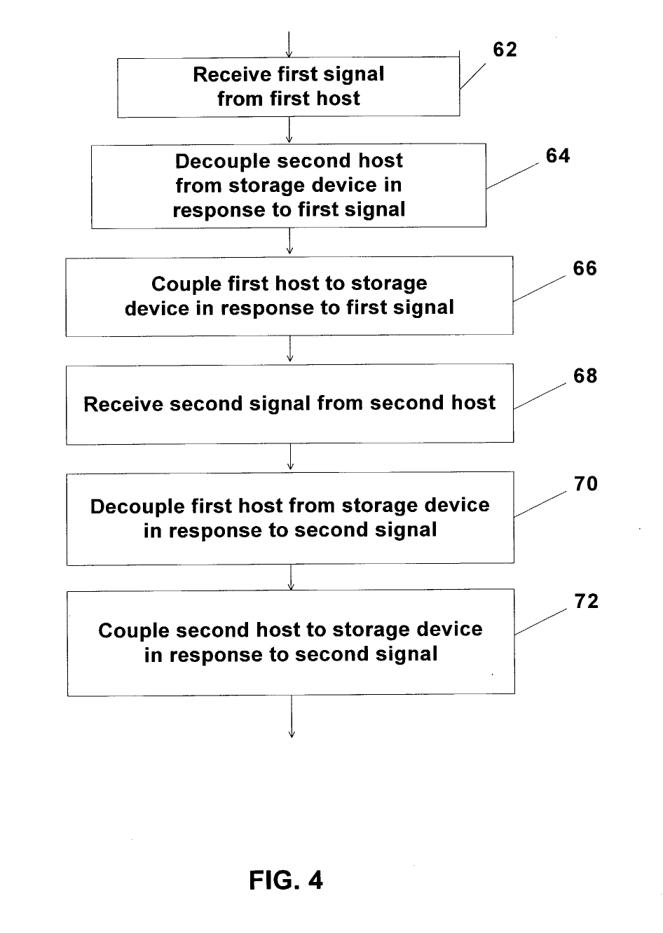

FIG. 4 illustrates functionality according to some embodiments of the inventions in flowchart form. This functionality could be included, for example, within switch 26 of system 20 illustrated in FIG. 1 or within switch 36 of system 30 illustrated in FIG. 2 or in other embodiments of the inventions. A first signal is received from a first host (could be an inactive host) at box 62. In response to the first signal, a second host (could be an active host) is decoupled from a storage device at box 64. In response to the first signal, the first host is coupled to the storage device at box 66.

A second signal is received from the second host (could now be an inactive host) at box 68. In response to the second signal, the first host (could now be an active host) is decoupled from the storage device at box 70. In response to the second signal, the second host is coupled to the storage device at box 72. Flow can then return to the beginning of box 62 and the process can be repeated or flow can end.

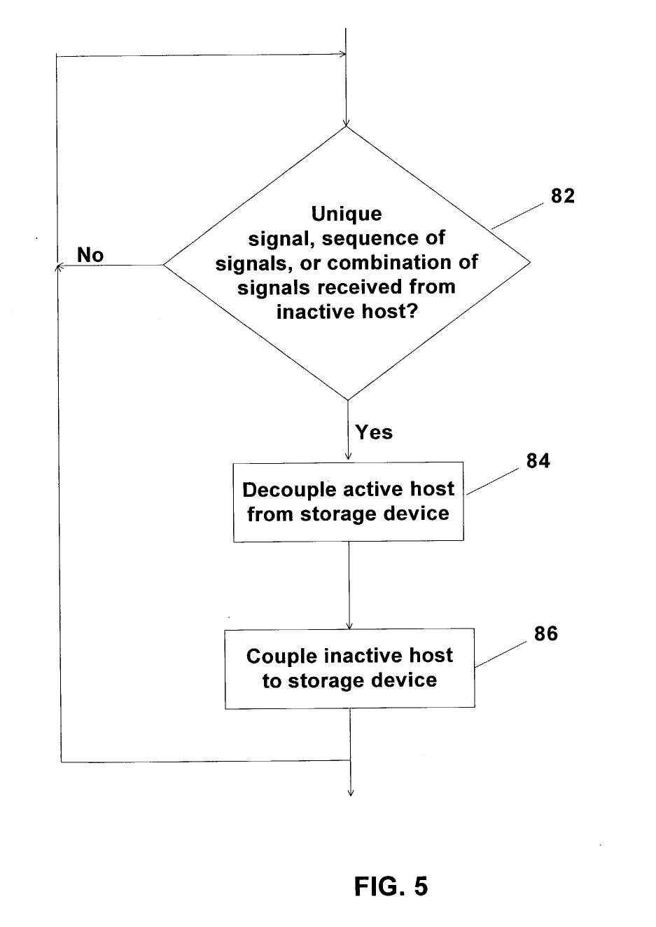

FIG. 5 illustrates functionality according to some embodiments of the inventions in flowchart form. This functionality could be included, for example, within switch 26 of system 20 illustrated in FIG. 1 or within switch 36 of system 30 illustrated in FIG. 2 or in other embodiments of the inventions. Diamond 82 determines whether or not a unique signal, unique sequence of signals or unique combination of signals has been received from an inactive host. If not, diamond 82 continues to determine whether or not the unique signal, sequence or combination has been received. If and/or when diamond 82 determines that a unique signal, sequence of signals or combination of signals has been received from an inactive host, box 84 decouples the active host (and/or an active host port) from a storage device (and/or a storage port). Box 86 couples an inactive host (and/or an inactive host port) to the storage device (and/or the storage port). Flow can then end or be returned to the input of diamond 82. Additionally in some embodiments of the inventions, upon detection of the signal, sequence or combination in diamond 82, flow can move to box 84 or box 86 only and then return to diamond 82.

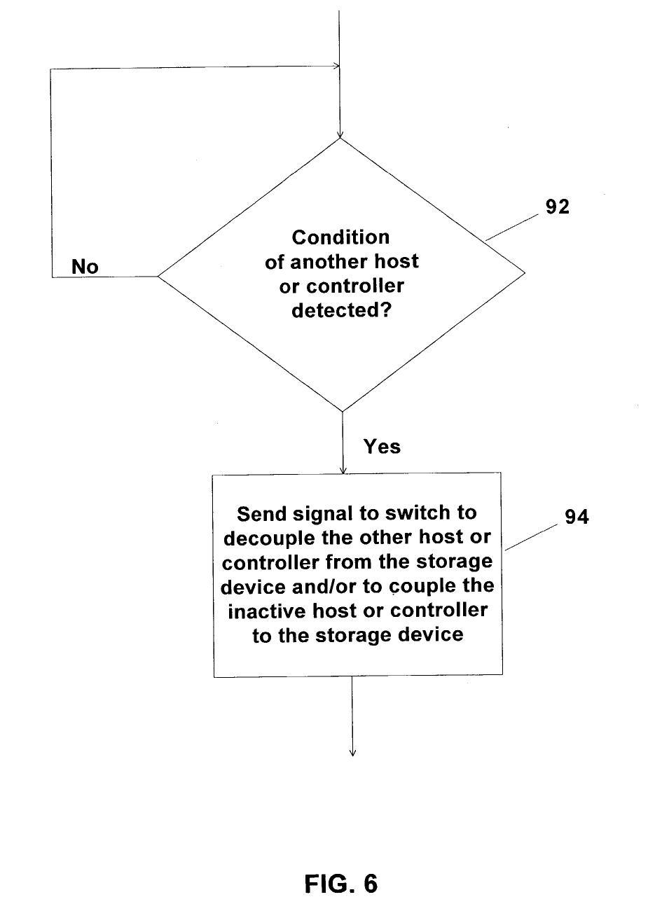

FIG. 6 illustrates functionality according to some embodiments of the inventions in flowchart form. This functionality could be included, for example, within first host 22 and/or second host 24 illustrated in FIG. 1 or within first host 32 and/or second host 34 illustrated in FIG. 2. One or more of first host 22, second host 24, first host 32 and/or second host 34 could be a storage controller in which the functionality illustrated in FIG. 6 could be included, or one or more of first host 22, second host 24, first host 32 and/or second host 34 could include a storage controller in which the functionality illustrated in FIG. 6 could be included. Any one or more of these hosts or storage controllers could also be a RAID controller. Diamond 92 of FIG. 6 determines whether or not a condition or conditions of another host or controller (could be an active host or active controller) has occurred. The detected or determined conditions could include a failure, a hung state, or some other condition of the other host or controller. If the condition is not determined/detected in diamond 92, diamond 92 continues to determine whether or not the conditions have occurred. If diamond 92 determines that a condition or conditions have occurred box 94 sends a signal to a switch (switch could be a storage switch and/or a storage fail-over device or some other logic, functionality or connection) to decouple the other host or controller from a storage device and/or to couple the host or controller (could be an inactive host or inactive controller) to the storage device. The signal sent in box 94 could be a unique signal, a unique sequence of signals or unique combination of signals. Flow can then end or be returned to the input of diamond 92.

In some embodiments of the inventions the unique signal may be issued using software. Such an implementation would not require built in hardware support to create the signal. Software would be able to assert a signal such as the COMRESET signal described in some embodiments of the inventions by setting the DET field in the Serial ATA SControl register to a value of ‘1’. Software can also cease sending the signal by setting the DET field in the Serial ATA SControl register to a value of ‘0’ (‘0’ being a signal not to initiate communication) or ‘4’ (which takes the Phy into an off-line mode).

In some embodiments of the inventions a unique Morse code type signal is used. In such an embodiment the unique Morse code signal may be continually sent to the switch until the switch recognizes the signal. For example, the switch may only need to see four bursts of the signal in a row before it performs the switch. However, more than four bursts may sometimes be necessary, so some embodiments of the inventions allow for the host to continuously send the unique Morse code type signal. Being able to continuously transmit the signal until it gets through can be important for robustness of the system since many host controllers send the COMRESET signal every 100 milliseconds or so to check for a device that has been hot plugged.

In some embodiments of the inventions reception of the unique signal (e.g., a port selection signal) on the inactive host port causes the fail-over device to deselect the currently active host port and select the host port over which the port selection signal is received. The switch selection signal is defined such that it can be generated using existing mechanisms and such that it can be received and decoded without the need for the fail-over device to include a full Link or Transport layer (i.e. direct Phy detection of the signal).

The port selection signal may be based on a pattern of COMRESET OOB (out of band) signals transmitted from the host to the fail-over device. The fail-over device may qualify only the timing from the assertion of a COMRESET signal to the following assertion of the COMRESET signal in detecting the port selection signal.

In some embodiments of the inventions as illustrated in FIG. 7 the port selection signal is defined as a series of COMRESET signals with the timing from the assertion of one COMRESET signal to the assertion of the next. The fail-over device may select the port, if inactive, after receiving two complete back-to-back sequences with specified inter-burst spacing over that port (i.e. two sequences of two COMRESET intervals comprising a total of five COMRESET bursts with four inter-burst delays). Reception of COMRESET signals over an active port is propagated to the device without any action taken by the fail-over device.

The interpretation and detection of the COMRESET signal by the fail-over device may be in accordance with the Serial ATA 1.0 definition. That is, the COMRESET signal may be detected upon receipt of the fourth burst that complies with the COMRESET signal timing definition. The inter-reset timings referred to here for the port selection signal are from the detection of a valid COMRESET signal to the next detection of such a signal, and are not related to the bursts that comprise the COMRESET signal itself.

In order to ensure the port selection signal is reliably conveyed to the fail-over device, the host should account for any other interface activity that may interfere with the transmitted COMRESET port selection sequence. For example, if the host periodically issues a COMRESET signal as part of a hardware-polled device presence detection mechanism, such a periodic COMRESET signal could occur during the port selection signaling sequence, thereby corrupting the port selection sequence. In order to avoid such interactions, the host may elect to continually transmit the port selection sequence while monitoring the associated Phy status in the associated superset register. When the port selection signal is recognized by the fail-over device and has taken effect, the host can detect a change in the PhyRdy status since the associated port will be activated and communications with it will be established.

In some embodiments of the inventions using a COMRESET signal (or some other signal), the COMRESET signal may be sent, then after a predetermined time interval T1 a COMRESET signal may be sent. Then after a predetermined time interval T2 a COMRESET signal is sent. The T1 and T2 time intervals may be alternated, or some other time intervals (for example, T3 and/or T4) may also be used such that a COMRESET signal is sent and a certain time interval occurs after (e.g., T1, T2, T3, T4, T4, etc). The time intervals may also loop back such that an interval such as the following is used: COMRESET signal is sent, wait T1, COMRESET sent, wait T2, COMRESET sent, wait T1, COMRESET sent, wait T2, etc. This may be implemented any number of times with any number of intervals.

In some embodiments of the inventions specific arrangements of the unique signal, unique sequence of signals or unique combination of signals may be implemented. Some embodiments of the signal(s) are described herein. The embodiments of the inventions may include those relating to a Serial ATA protocol environment or some other implementation.

In each system shown in a figure, the elements such as hosts, switches, storage devices, storage fail-over devices, for example, each have a different reference number to suggest that the elements represented could be different. However, an element may be flexible enough to have different implementations and work with some or all of the systems shown or described herein. The various ports shown in the figures may be the same or different. Which one is referred to as a first host and which is called a second host is arbitrary.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

What is claimed is:

1. An apparatus comprising:
a first host port to couple to and to communicate using a communication protocol with at least one of a first host and a first controller;
a second host port;
a storage port; and
a switch to decouple the second host port from the storage port in response to a signal to be received via the first host port and to couple the first host port to the storage port in response to the signal to be received via the first host port, wherein the signal is a valid signal in the communication protocol.

2. The apparatus as claimed in claim 1, wherein the signal to be received via the first host port is a unique sequence of valid signals in the communication protocol.

3. The apparatus as claimed in claim 2, wherein the unique sequence of signals is a unique pattern of hard reset signals.

4. The apparatus as claimed in claim 2, wherein the unique sequence of signals is a Morse code type of sequence of signals.

5. The apparatus as claimed in claim 1, wherein the signal to be received via the first host port is a unique combination of valid signals in the communication protocol.

6. The apparatus as claimed in claim 1, wherein the communication protocol is a Serial ATA protocol.

7. The apparatus as claimed in claim 6, wherein the unique signal is a unique sequence of the Serial ATA protocol COMRESET signal.

8. The apparatus as claimed in claim 1, wherein the first host port is coupled to a first storage controller and the second host port is coupled to a second storage controller.

9. The apparatus as claimed in claim 8, wherein the first storage controller is a RAID controller and the second storage controller is a RAID controller.

10. The apparatus as claimed in claim 1, wherein the storage port is coupled to a storage device comprising at least one disk drive.

11. The apparatus as claimed in claim 1, wherein the communications protocol is a Serial ATA protocol, the first host port is to be coupled to a first host using the Serial ATA protocol and the second port is to be coupled to a second host using the Serial ATA protocol.

12. The apparatus as claimed in claim 11, further comprising:
a first Serial ATA PHY to couple the switch to the first host port; and
a second Serial ATA PHY to couple the switch to the second host port.

13. The apparatus as claimed in claim 12, further comprising a third Serial ATA PHY to couple the switch to the storage port.

14. The apparatus as claimed in claim 1, wherein the second host port is to couple to and communicate with at least one of a second host and a second controller using the communication protocol and the switch is further to decouple the first host port from the storage port in response to a unique signal to be received via the second host port and to couple the second host port to the storage port in response to the unique signal to be received via the second host port, wherein the unique signal to be received via the second host port is a valid signal or combination of valid signals in the communication protocol.

15. The apparatus as claimed in claim 14, wherein the unique signal to be received via the first host port is a first unique sequence of signals and wherein the signal to be received via the second host port is a second unique sequence of signals, and the first unique sequence of signals is the same as or different than the second unique sequence of signals.

16. A method comprising:
receiving a signal from a first host, wherein the signal is a valid signal in a communication protocol used to communicate with the first host;
decoupling a second host from a storage device in response to the signal; and
coupling the first host to the storage device in response to the signal.

17. The method as claimed in claim 16, wherein the signal is a unique sequence of valid signals in the communication protocol.

18. The method as claimed in claim 17, wherein the unique sequence of signals is a unique pattern of hard reset signals.

19. The method as claimed in claim 17, wherein the unique sequence of signals is a Morse code type of sequence of signals.

20. The method as claimed in claim 16, wherein the signal is a unique combination of valid signals in the communication protocol.

21. The method as claimed in claim 16, wherein the communication protocol is a Serial ATA protocol.

22. The method as claimed in claim 21, wherein the unique signal is a unique sequence of the Serial ATA protocol COMRESET signal.

23. The method as claimed in claim 16, further comprising:
receiving a signal from the second host, wherein the signal received from the second host is a valid signal in a communication protocol used to communicate with the second host;
decoupling the first host from the storage device in response to the signal received from the second host; and
coupling the second host to the storage device in response to the signal received from the second host.

24. The method as claimed in claim 23, wherein the signal received from the first host is a first unique sequence of signals and wherein the signal received from the second host is a second unique sequence of signals, where the first unique sequence of signals is the same as or different than the second unique sequence of signals.

25. A system comprising:
a first host;
a second host;
a storage device; and
a switch coupled to the first host, the second host and the storage device, the switch communicating with the first host using a communication protocol, the switch to decouple the second host from the storage device in response to a signal received from the first host, and to couple the first host to the storage device in response to the signal received from the first host, wherein the signal is a valid signal in the communication protocol.

26. The system as claimed in claim 25, where the first host comprises a first storage controller and the second host comprises a second storage controller, and the switch is coupled to the first storage controller and the second storage controller, the switch to decouple the second storage controller from the storage device in response to a signal received from the first storage controller, and to couple the first storage controller to the storage device in response to the signal received from the first storage controller.

27. The system as claimed in claim 26, wherein the first storage controller is a first RAID controller and the second storage controller is a second RAID controller.

28. The system as claimed in claim 25, wherein the storage device includes at least one hard drive.

29. The system as claimed in claim 25, wherein the signal is a unique sequence of valid signals in the communication protocol.

30. The system as claimed in claim 26, wherein the unique sequence of signals is a unique pattern of hard reset signals.

31. The system as claimed in claim 26, wherein the unique sequence of signals is a Morse code type of sequence of signals.

32. The system as claimed in claim 25, wherein the signal is a unique combination of valid signals in the communication protocol.

33. The system as claimed in claim 25, wherein the communication protocol is a Serial ATA protocol.

34. The system as claimed in claim 33, wherein the signal is a unique sequence of the Serial ATA protocol COMRESET signal.

35. The system as claimed in claim 25, wherein the switch is further to decouple the first host from the storage device in response to a signal received from the second host and to couple the second host to the storage device in response to the signal received from the second host, wherein the signal received from the second host is a valid signal in a communication protocol used between the switch and the second host.

36. The system as claimed in claim 35, wherein the signal received from the first host is a first unique sequence of signals and wherein the signal received from the second host is a second unique sequence of signals, where the first unique sequence of signals is the same as or different than the second unique sequence of signals.

37. The system as claimed in claim 25, wherein the first host provides the signal based on a condition of the second host.

38. A host computer comprising:
a port to be coupled to a switch; and
a controller to provide a signal via the port to the switch, the signal indicating to the switch to couple the host computer to a storage device and to decouple an other host computer from the storage device, wherein the signal is a valid signal in a communication protocol used between the host computer and the switch.

39. The host computer as claimed in claim 38, wherein the host computer comprises a first storage controller and the other host computer comprises a second storage controller.

40. The host computer as claimed in claim 39, wherein the first storage controller is a first RAID controller and the second storage controller is a second RAID controller.

41. The host computer as claimed in claim 38, wherein the controller provides the signal based on a failure condition of the other host.

42. The host computer as claimed in claim 38, wherein the signal is a unique sequence of signals.

43. The host computer as claimed in claim 38, wherein the unique sequence of signals is a unique pattern of hard reset signals.

44. A method comprising:
detecting a condition of an active host; and
sending a signal based on the detected condition to decouple the active host from a storage device and to couple an inactive host to the storage device, wherein the signal is a valid signal in a communication protocol used by the inactive host.

45. The method as claimed in claim 44, wherein the active host comprises a first storage controller and the inactive host comprises a second storage controller.

46. The method as claimed in claim 44, wherein the signal is a unique sequence of signals.

47. The method as claimed in claim 44, wherein the condition is a failure condition of the active host.

48. The method as claimed in claim 44, wherein the signal is transmitted in-band over active links between the host and the storage device.

49. The method as claimed in claim 44, wherein the signal is a valid signal in a protocol used to couple the host with the storage device.

50. The method as claimed in claim 44, wherein the signal is a sequence of hard reset signals.

51. The method as claimed in claim 50, wherein the sequence of hard reset signals is provided in a Morse code sequence.

52. The method as claimed in claim 50, wherein the hard reset signals are COMRESET signals.
